(19) United States
(12) Patent Application Publication
(10) Pub. No.: US 2005/0210089 A1
(43) Pub. Date: Sep. 22, 2005

(54) Saturating shift mechanisms within data processing systems

(75) Inventors: Daniel Kershaw, Austin, TX (US); Micah Rone McDaniel, Austin, TX (US)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 10/804,181

(22) Filed: Mar. 19, 2004

(51) Int. Cl. G06F 7/00

(52) U.S. Cl. 708/209

(57) ABSTRACT

A saturating shifter is provided which operates to detect in parallel with a shifting operation whether the result of that shifting operation will require saturating. If saturation is required, then the necessary saturating mask may be determined earlier and accordingly processing speed increased.

### BACKGROUND OF THE INVENTION

1. Field of the Invention

This invention relates to the field of data processing systems. More particularly, this invention relates to saturating shift mechanisms within data processing systems.

2. Description of the Prior Art

It is known to provide data processing program instructions which specify shift operations to be performed upon input data values. As a refinement to such mechanisms it is known to combine a saturating function with a shift whereby if the shifted output value is outside of the range of values which can be represented by the bits available within the output data value, then a saturated value is instead returned at the appropriate limiting extreme of the range of values which may be represented. This type of behavior is particularly useful in digital signal processing operations.

FIG. 1 of the accompanying drawings schematically illustrates a possible micro-architecture which might be used to achieve this result. In this micro-architecture, a data value is shifted by an amount dependent upon a control signal specifying the shift amount. The shifting is in practice performed by a data value rotating circuit and accordingly a mask is generated under control of the control signal to mask out the bits which have been shifted out of the result. The mask when generated is applied to the rotated data value. The rotated data value is also checked to see if bits within the out of range positions indicate that it should be saturated, and, if necessary, subsequent saturation is performed. The determination of the requirement to saturate in a serial fashion following the shifting/rotating operation introduces an extra processing delay which is disadvantageous and may in some circumstances constrain pipeline timing.

### SUMMARY OF THE INVENTION

Viewed from one aspect the present invention provides apparatus for performing a saturating shift operation upon an input data value to generate an output data value, said apparatus comprising:
a data shifting circuit operable to shift an input data value by a shift amount dependent upon an input shift amount to generate a shifted data value;
a mask generating circuit operable to generate a mask value; and
a masking circuit operable to apply said mask value to said shifted data value to generate said output data value; wherein
said mask generating circuit operates in parallel with said data shifting circuit to detect in dependence upon said input data value and said input shift amount if said output data value should be saturated and, if said output data value should be saturated, then generates a mask value to control said masking circuit to generate a saturated data value as said output data value.

The present technique recognizes that the requirement to saturate the output can be identified from the input data value and the shift amount and that it is not necessary to wait until the shifted or rotated value has been generated to make this determination. Performing this evaluation earlier eases timing considerations and thus enables faster operation.

In preferred embodiments of the invention, the shifting is performed by a data value rotating circuit and accordingly a mask value is used to generate the output data value from the rotated data value. Rotation can be considered to be a subset of shifting in general. The mask circuit thus provided can be re-used to perform any required saturation without requiring additional circuitry in the data path. The complexity of performing this saturation determination is effectively transferred into the control plane rather than in the data plane of operation.

In preferred embodiments of the invention, the mask value is also operable to control sign extending if required.

It will be appreciated that the detection of whether or not saturation is required may be performed directly from the input data value or alternatively may be performed from partially shifted or rotated version of the input data value partway through its shifting or rotation. Allowing such control to be made from a partially processed result can enable the shifting or rotation to be commenced prior to the signals being available to control how the input data value is to be evaluated to determine whether or not saturation is required.

In preferred embodiments, improved speed is achieved when the masking circuit comprises a combinatorial logic array.

Whilst the shifting operations may be ones in which data width is maintained, preferred embodiments of the invention are well suited to situations in which shifting results in a simultaneous data width narrowing. This type of behavior is particularly useful in digital signal processing situations where multiply-accumulate sequences have been performed and then the final result needs to be normalized back down to the normal data width.

When such data width reduction takes place, it is preferred to determine whether or not saturation should be required prior to the data width reduction being performed since this simplifies implementation.

The mask values that are applied could take a variety of different forms and may be calculated in a variety of different ways (e.g. from an appropriate combinatorial logic or through lookups from input control signals). In preferred embodiments the mask values have a thermometer coded type of arrangement in which they are formed of at least one of a run of binary ones and a run of binary zeros separating the portion to be maintained and the portion to be masked out. These mask values can be used in their direct form or alternatively as their complement if required and can be reused to give saturated results.

The shifter of the present technique is preferably controllable to either support saturating or non-saturating operation by adjusting control signals to change the mask generation. Similarly, both signed and unsigned variant behavior can be achieved by adjustment of the mask signals to be responsive to the sign of the input data.

Viewed from another aspect the present invention provides a method of performing a saturating shift operation upon an input data value to generate an output data value, said method comprising the steps of:
shifting an input data value by a shift amount dependent upon an input shift amount to generate a shifted data value;
generating a mask value; and
masking said shifted data value with said mask value to generate said output data value; further comprising the step of:
in parallel with said shifting, detecting in dependence upon said input data value and said input shift amount if said output data value should be saturated and, if said output data value should be saturated, then generating a mask value to control said masking to generate a saturated data value as said output data value.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates one possible way in which a saturating shifting mechanism may be provided;

FIG. 2 schematically illustrates an example of the present technique whereby a determination as to whether or not saturation is required is performed in parallel with the shifting/rotation;

FIG. 3 is a diagram illustrating the rotating and masking circuitry in more detail; and

FIG. 4 is a diagram schematically illustrating the processing operations performed in accordance with one example of the present technique.

### DESCRIPTION OF THE PREFERRED EMBODIMENTS

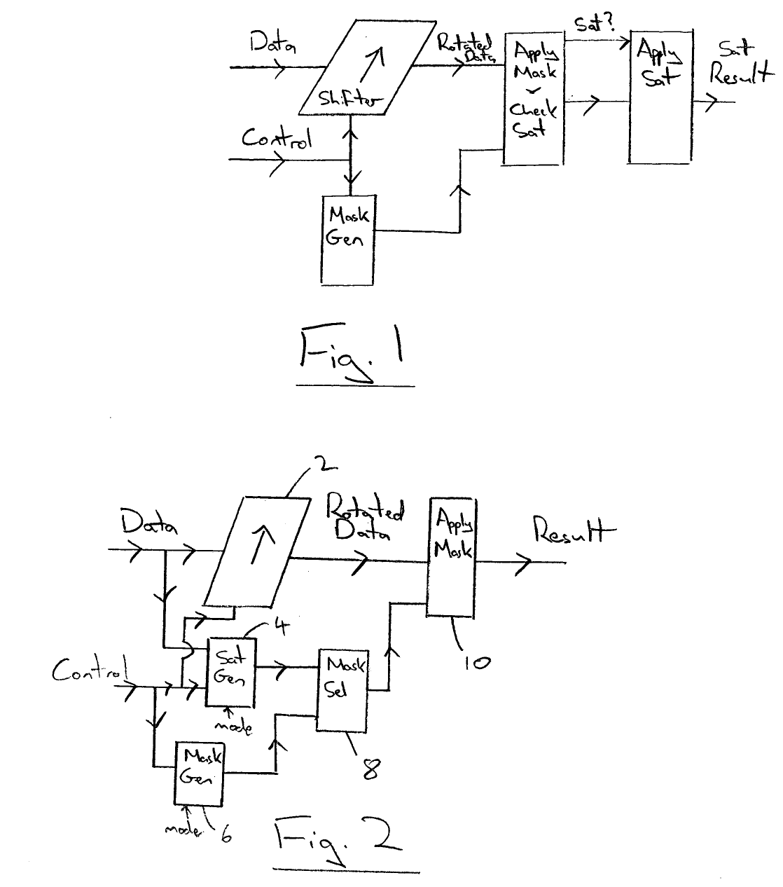

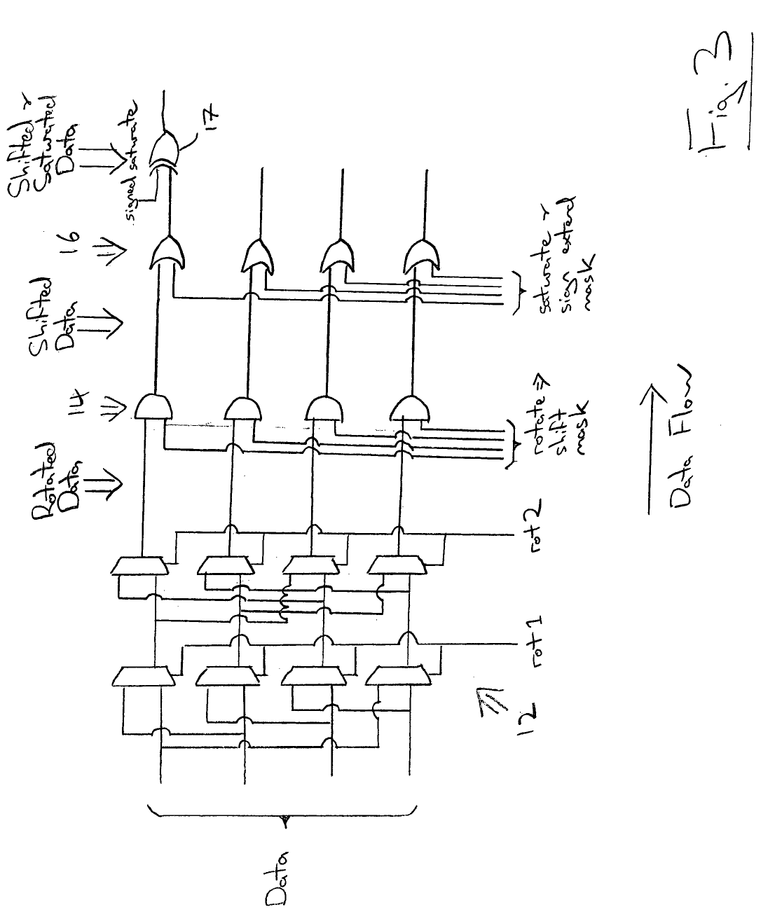

FIG. 2 illustrates a saturating shifting mechanism comprising a data rotating circuit 2 responsive to a control signal value specifying a shift (rotation) amount by which to a rotate input data value to generate a rotated data value. In parallel with the action of the shifting circuit 2, the control data and the input data value is input to a saturation mask generator 4 which determines from the control value and the input data value whether the result will be outside of the range possible to represent with the number of bits in the output data value. When outside of the representable range, the output data value is saturated to either a maximum value or a minimum value depending upon which end of the possible range has been exceeded. A mask generator circuit 6 also serves to generate a mask operable to convert the rotated data value into a shifted data value by masking out those bits which have rotated past the end of the data value and wrapped. The saturation detector 4 and the mask generator 6 are illustrated in FIG. 2 as separate entities but it will be appreciated that they may be provided as a single functional unit and a convenient form of this would be as a lookup table based circuit driven by the input data value and the control value to generate a suitable mask.

The mask to be used, either a saturating mask or a non-saturating mask is selected by unit 8 and then applied by a combinatorial logic array 10 to generate an output data value.

A mode signal is also input to the mask generating mechanisms 4, 6 and serves to selectively switch between such saturating and non-saturating modes of operation and signed and un-signed data representations within the input data word. Sign extension can be accommodated by appropriate selection of a mask to be applied by the combinatorial logic, either in a single stage or in a multi-stage masking operation. Within a scaler embodiment, the data width may also be narrowed by appropriate masking and control if desired. Within a SIMD embodiment the data width of each data element may be narrowed by appropriate masking and control, e.g. two registers input and one register output. Saturation detection is performed before narrowing. The saturation detection may be responsive to a partially rotated/shifted version of the input data value rather than the unaltered data value if desired.

A significant feature of the circuit of FIG. 2 is that the saturation detection takes place in parallel with the shifting. This speeds the circuit operation and removes a potential bottleneck from the system performance.

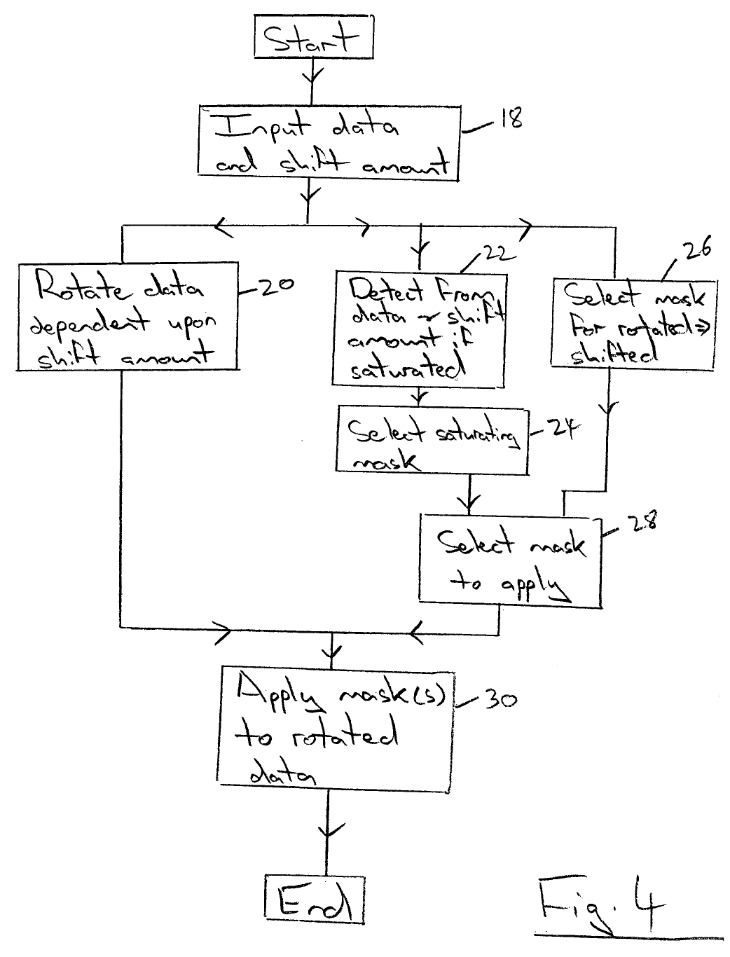

FIG. 3 schematically illustrates a saturating shifting mechanism in accordance with the present technique in more detail. As illustrated, an array of 2-way multiplexers 12 serve to sequentially apply either a single position rotation or a two position rotation depending upon input control signals. The rotated data is then passed through respective AND gates 14 which serve to convert the rotated data into shifted data by appropriately masking out those bits which have wrapped during the rotation. This generates shifted data from the rotated data. In the case of a requirement to saturate toward the minimum value (signed is toward negative max 1000 . . . , unsigned toward zero 0000 . . . ), the AND gates 14 may also serve to saturate the data value. An array of OR gates 16 then serves to apply a second mask which operates to either saturate (toward the maximum value−signed 0111 . . . , unsigned 1111 . . . ) or sign extend the shifted data (or narrow) to produce the output data. Signed values will be saturated to positive maximum and signed values saturated to all ones. The most significant bit is inverted in the signed saturated case with an XOR gate 17.

Viewed in another way, the AND gates 14 make sure that no 1s from the rotation are passed through to the final result when we staurate to MAX −ve. The OR gates 16 make sure there is always a 1 in the result when we staurate to MAX +ve, regardless of the rotation value. The XOR gate 17 inverts the most significant bit when we have a signed saturate.

As an example of mask values that may be used in the example of FIG. 3:

Shift right (assume only +ve shift values)

| | AND Mask | OR Mask | XOR Mask |
|---|---|---|---|
| Other: | 0000 | ssss | 0 |
| 3: | 0001 | sss0 | 0 |
| 2: | 0011 | ss00 | 0 |
| 1: | 0111 | s000 | 0 |
| 0: | 1111 | 0000 | 0 |

s = Signed & Data[3]

Shift left (assume only +ve shift values)

| | AND Mask | OR Mask | XOR Mask |
|---|---|---|---|
| Other: | 0000 | dddd | X |
| 3: | 1000 | cccc | X |
| 2: | 1100 | bbbb | X |
| 1: | 1110 | aaaa | X |
| 0: | 1111 | 0000 | 0 |

a = (D[3] & Saturate & ˜Signed) | (˜D[3] & D[2] & Saturate & Signed)
b = (|(D[3:2]) & Saturate & ˜Signed) | (˜D[3] & (|D[2:1]) & Saturate & Signed)
c = (|(D[3:1]) & Saturate & ˜Signed) | (˜D[3] & (|D[2:0]) & Saturate & Signed)
d = (|(D[3:0]) & Saturate & ˜Signed) | (˜D[3] & (|D[2:0]) & Saturate & Signed)
X = Signed & Saturate & (a | b | c| d)

FIG. 4 is a diagram schematically illustrating the processing which may be performed in accordance with one example embodiment. At step 18, an input data value is received and a shift amount to be applied is specified. At step 20, a rotated data value is formed from the input data value in dependence upon the specified shift amount. In parallel with the rotation of step 20, steps 22, 24, 26 and 28 act as follows. Step 22 detects from the data and a shift amount if the output data value will require saturation due to exceeding the allowable limits. If saturation is required, then step 24 selects an appropriate saturating mask to be applied. In parallel with steps 22 and 24, step 26 selects an appropriate mask for converting from a rotated data value to a shifted data value. Step 28 selects either the saturating mask produced at step 24 or the mask for converting from rotated to shifted data produced at step 26. Step 30 then applies the mask to the rotated data value to generate the output data value.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. Apparatus for performing a saturating shift operation upon an input data value to generate an output data value, said apparatus comprising:
a data shifting circuit operable to shift an input data value by a shift amount dependent upon an input shift amount to generate a shifted data value;
a mask generating circuit operable to generate a mask value; and
a masking circuit operable to apply said mask value to said shifted data value to generate said output data value; wherein
said mask generating circuit operates in parallel with said data shifting circuit to detect in dependence upon said input data value and said input shift amount if said output data value should be saturated and, if said output data value should be saturated, then generates a mask value to control said masking circuit to generate a saturated data value as said output data value.

2. Apparatus as claimed in claim 1, wherein said data value shifting circuit is a data value rotating circuit operable to rotate an input data value by a rotation amount dependent upon an input shift amount to generated a rotated data value as said shifted data value and, if said output data value should not be saturated, then said mask generating circuit generates a mask value to control said masking circuit to generate a shifted data value not outside of saturating limits as said output data value.

3. Apparatus as claimed in claim 1, wherein said mask value is also operable to control sign extending of said output data value.

4. Apparatus as claimed in claim 1, wherein said mask generating circuit is responsive to a partially shifted data value to detect if said output data value should be saturated.

5. Apparatus as claimed in claim 1, wherein said masking circuit is a combinatorial logic array.

6. Apparatus as claimed in claim 1, wherein data value rotating circuit and said masking circuit are operable to reduce data width of said input data value when generating said output data value.

7. Apparatus as claimed in claim 6, wherein said mask generating circuit detects if said output data value should be saturated in dependence upon said input data value before data width reduction.

8. Apparatus as claimed in claim 1, wherein said apparatus is operable to perform a plurality of separate saturating shift operations in parallel upon respective portions of said input data value as part of single instruction multiple data operation.

9. Apparatus as claimed in claim 1, wherein said mask values are mask values divided into at least one of a run of binary ones and a run of binary zeros.

10. Apparatus as claimed in claim 1, wherein one or more control signals switch said apparatus between modes providing at least one of:
saturating operation or non-saturating operation;
signed output generation or non-signed output generation; and
narrowing or non-narrowing output generation.

11. A method of performing a saturating shift operation upon an input data value to generate an output data value, said method comprising the steps of:
shifting an input data value by a shift amount dependent upon an input shift amount to generate a shifted data value;
generating a mask value; and
masking said shifted data value with said mask value to generate said output data value; further comprising the step of:
in parallel with said shifting, detecting in dependence upon said input data value and said input shift amount if said output data value should be saturated and, if said output data value should be saturated, then generating a mask value to control said masking to generate a saturated data value as said output data value.

12. A method as claimed in claim 11, wherein said data value shifting circuit is a data value rotating circuit operable to rotate an input data value by a rotation amount dependent upon an input shift amount to generated a rotated data value as said shifted data value and, if said output data value should not be saturated, then said mask generating circuit generates a mask value to control said masking circuit to generate a shifted data value not outside of saturating limits as said output data value.

13. A method as claimed in claim 11, wherein said mask value is also operable to control sign extending of said output data value.

14. A method as claimed in claim 11, wherein said mask generation is responsive to a partially shifted data value to detect if said output data value should be saturated.

15. A method as claimed in claim 11, wherein said masking is performed by a combinatorial logic array.

16. A method as claimed in claim 11, wherein data width of said input data value is reduced when generating said output data value.

17. A method as claimed in claim 16, wherein detecting if said output data value should be saturated in dependence upon said input data value is performed before said data width is reduced.

18. A method as claimed in claim 11, wherein a plurality of separate saturating shift operations are performed in parallel upon respective portions of said input data value as part of single instruction multiple data operation.

19. A method as claimed in claim 11, wherein said mask values are mask values divided into at least one of a run of binary ones and a run of binary zeros.

20. A method as claimed in claim 11, wherein one or more control signals switch said between modes providing at least one of:
saturating operation or non-saturating operation;
signed output generation or non-signed output generation; and
narrowing or non-narrowing output generation.
